(19) United States
(12) Patent Application Publication
(10) Pub. No.: US 2003/0122068 A1
(43) Pub. Date: Jul. 3, 2003

(54) Easy-to-plug-in inlet for mass spectrometers

(76) Inventors: Stefan Berking, Bergisch Gladbach (DE); Klaus Herrmann, Huerth (DE)

Correspondence Address: Stefan Berking, Im Bruch 10, Bergisch Gladbach, D-51427, DE

(21) Appl. No.: 10/036,260

(22) Filed: Jan. 3, 2002

(51) Int. Cl. H01J 49/04

(52) U.S. Cl. 250/288

(57) ABSTRACT

An easy-to-plug-in inlet is presented for various commercial mass spectrometers which enables ready and simple plugging into the mass detector thereby removing pollutants or a blockage of the entrance orifice by substances, restoring sensitivity and selectivity of the mass detection within minutes, and greatly reducing the time of standstill and of the costs. The easy-to-plug-in inlet can easily be adapted to the various mass spectrometers. In its simplest form the original entrance orifice of the mass spectrometer is enlarged and a tube is plugged in with a central bore of the very same diameter as the original orifice.

### CROSS-REFERENCE TO RELATED APPLICATIONS

| | |
|---|---|
| Meuzelaar | US-4408125 October 1983 |
| Studenick | US-4046012 September 1977 |
| Hurst | US-4985625 January 1991 |

### STATEMENT REGARDING FEDERALLY SPONSORED RESEARCH OR DEVELOPMENT

—not applicable—

### REFERENCE TO A SEQUENCE LISTING, A TABLE, OR A COMPUTER PROGRAM LISTING COMPACT DISC APPENDIX

—not applicable—

### BACKGROUND OF THE INVENTION

1. Field of the Invention

A mass spectrometer determines the mass to charge ratio of ions.

The Ions are usually generated by an ion-source and they are subsequently transferred through an inlet with a small orifice to the mass detector.

2. State of the Related Art

There exist various types of inlets to mass spectrometers depending on the various manufactors. However, in all cases the orifice of the inlet devices is about 0.4 to 1 mm because the entrance orifice is spaced in atmospheric pressure of the laboratory, whereas the exit orifice is within the vacuum chamber of the mass spectrometer (pressure 1-10 Torr). The rather small diameter of the inlet orifice favours pollution of the inlet, especially when coupling the mass spectrometer to liquid chromatography or to capillary electrophoresis. Pollutants settle inside the inlet. Whenever the pollutants detach, the accuracy, selectivity, and sensitivity of the mass detection drops. Up to now there is no effectiv method to prevent pollution of the inlet. When the orifice is blocked by substances, which happens especially when using aquaeous solutions containing salted buffers, mass detection is blocked, too. In order to restore proper function of the mass spectrometer, a new inlet device has to be installed, and the mass spectrometer has to be turned off. Due to the vacuum inside the mass spectrometer (1 times 10 sup-4 Torr), the system has to be vented to air and to atmospheric pressure. After reinstalling the new inlet, the system has to be pumped down again. The pumping takes up to 2 days depending on the type of mass spectrometer. During this time, operation of the mass spectrometer is possible at low sensitivity and selectivity, only. Re-installing the new inlet requires skilled and trained operators and can be rather expensive. Under laboratory conditions, inlets are usually re-installed on friday in order to get a high performance of mass detection on the following monday.

### OBJECTIVES OF THE INVENTION

It is an objective of the present invention to provide an inlet for various commercial mass spectrometers which is designed for ready and simple plugging into the mass detector thereby removing pollutants, restoring sensitivity and selectivity of the mass detection within minutes, and greatly reducing the time of standstill and of the costs.

### BRIEF SUMMARY OF THE INVENTION

The original orifice of the inlet of a commercial mass spectrometer is slightly enlarged mechanically. A new inlet (NI) is inserted, in its simplest form a tube, with the respective orifice and dimensions of the original inlet. The NI is designed for ready and simple plugging by hand. The NI may be modified at the inlet orifice by flaring or by mounting a cap or a disk to provide a handle for easy manual installation and to provide a stop for proper adjustment of the NI in the mass spectrometer. Depending on the type of mass spectrometer the material of the NI can be modified to match the requirements of this type of detector (shape, dimensions, material).

### BRIEF DESCRIPTION OF THE SEVERAL VIEWS OF THE INVENTION

The foregoing and other objectives of the invention will be more clearly understood from the description when read in conjunction with the accompanying drawings.

Because the inlets of commercial mass spectrometers vary greatly, two examples of the new inlet NI (hatched) are shown, only.

In the drawings

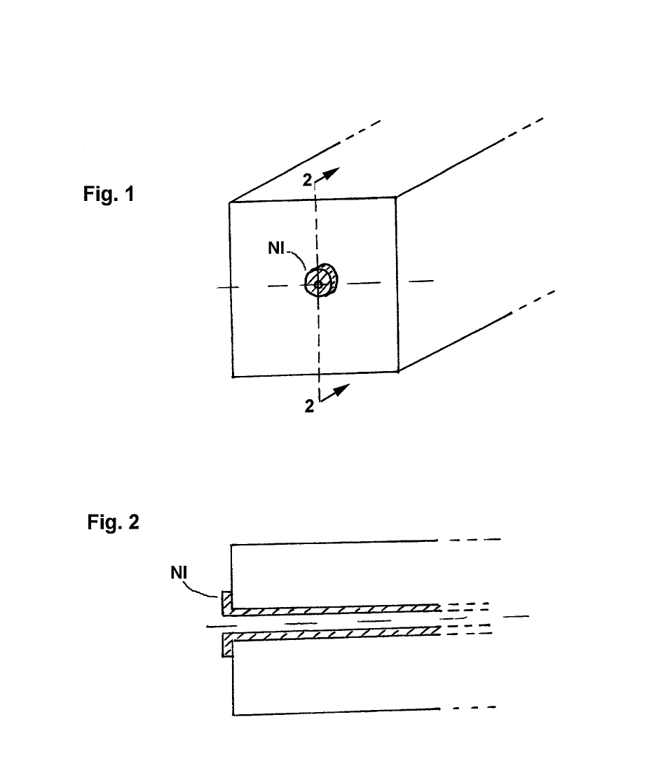

FIG. 1 is a schematic diagram of a NI mounted to a ‘block’ inlet system.

FIG. 2 is a schematic view of the cross section of the NI-mounting shown in FIG. 1 (sectional plane 1-1).

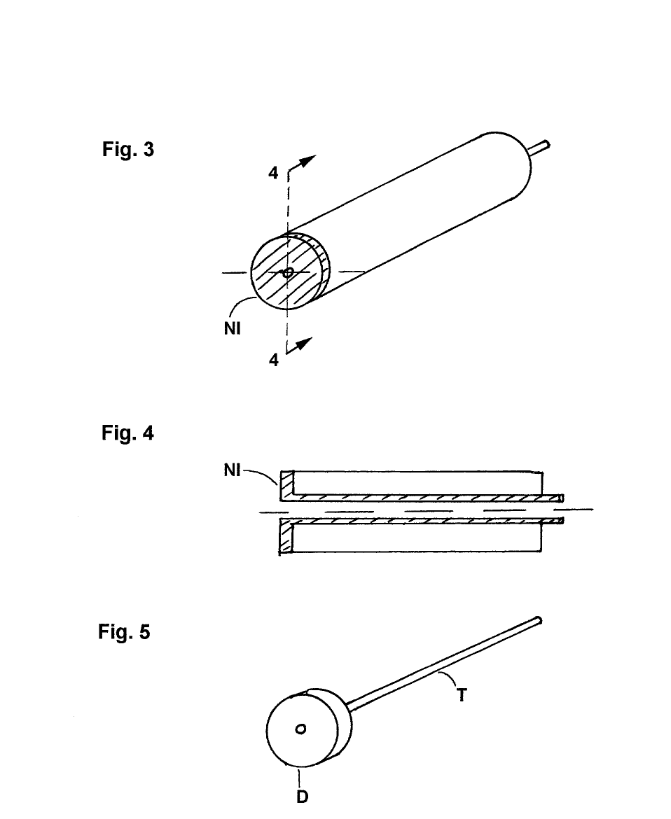

FIG. 3 is a schematic diagram of a NI mounted to a ‘capillary’ inlet system.

FIG. 4 is a schematic view of the cross section of the NI-mounting shown in FIG. 3 (sectional plane 3-3).

FIG. 5. is a schematic diagram of the NI shown in FIGS. 1-4, comprising a tube (T) and a disk (D) mounted to the front of the tube.

### ADVANTAGES OF THE INVENTION

A new inlet (NI) can be installed within seconds in case of pollution or blockage. There is no need to shut down the mass spectrometer, the vacuum inside the detector drops slightly, only. After a short period of time (in our experience 3-10 minutes), mass detection is realized at high sensitivity and selectivity. Pollutants from previous detections are removed reliably, there is no memory effect. This is very important for quantitative detection of small amounts (at picogram levels) of substances in cases of suspected drug abuse and in doping control. Especially when coupled to liquid chromatography, the present invention enables the use of salted, non-volatile buffers such as phosphate buffers in mass detection. Up to now, non-volatile buffers are strictly avoided because the inlet orifice of the mass spectrometer is inevitably blocked within hours. At present, volatile buffers are used such as ammonium acetate. However, in some cases it is not possible to adapt a prooved method in liquid chromatography from non-volatile to volatile buffers, because the separation and the identification of the substances is severely affected. The present invention overcomes this problem, the range of methods is greatly enlarged for coupling liquid chromatography to mass detection.

A polluted or blocked NI can easily be re-used after cleaning for example by means of certain solvents and/or by means of an ultrasonic bath. The cost of the NI is low. Even untrained persons can do the job of re-installation of the NI.

1. An easy-to-plug-in inlet for commercial mass spectrometers,
a) wherein the new inlet (NI) is installed into the original, modified inlet system of said mass spectrometer,
b) wherein said NI can easily be installed and be removed,
c) wherein said NI fits into said modified inlet system without interfering with the vacuum level of said mass spectrometer,
d) wherein said NI matches the requirements of said mass spectrometer with respect to its dimensions and its material.
e) wherein the material of said NI allows application of an electric potential to the said NI or an electric potential can be transferred to the NI by contact to the said modified inlet system of said mass spectrometer.
